(19) United States
(12) Patent Application Publication
(10) Pub. No.: US 2010/0138456 A1
(43) Pub. Date: Jun. 3, 2010

(54) SYSTEM, METHOD, AND COMPUTER-READABLE MEDIUM FOR A LOCALITY-SENSITIVE NON-UNIQUE SECONDARY INDEX

(76) Inventor: Alireza Aghili, Los Angeles, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/326,363

(22) Filed: Dec. 2, 2008

(51) Int. Cl. G06F 17/30; G06F 7/00

(52) U.S. Cl. 707/803; 707/E17.002

(57) ABSTRACT

A system, method, and computer-readable medium for allocation of a Locality-sensitive Non-Unique Secondary Index are provided. The Locality-sensitive Non-Unique Secondary Index preserves the similarity of incorporated fields as well as improves the average secondary index sub-table look-up performance and is advantageously resilient to the type of predicates and workloads applied thereto. Rows of the secondary index having values of the columns that are hashed to determine a secondary index sub-table row location have a higher probability of being closely located within the secondary index than rows with more dissimilar column values that are hashed to determine the secondary index row location.

### BACKGROUND

A database is a collection of stored data that is logically related and that is accessible by one or more users or applications. A popular type of database is the relational database management system (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

One of the goals of a database management system is to optimize the performance of queries for access and manipulation of data stored in the database. Given a target environment, an optimal query plan is selected, with the optimal query plan being the one with the lowest cost (e.g., response time) as determined by an optimizer. The response time is the amount of time it takes to complete the execution of a query on a given system.

In some cases, tables in a relational database system may contain a very large amount of data. For example, many large retail chains may operate relational databases that contain daily sales figures. The tables of daily sales figures may include millions or billions of rows and a large number of columns. A better access path is important in such cases because scanning all rows and/or columns in a large table is time consuming and may impose an unacceptable load on computing resources.

Typically, a database administrator defines an “index” that contains one or more frequently accessed columns on a table. An index is a smaller table which references columns in another table. Accessing a table through an index can avoid the need to perform an all-row scan on the table.

Equality, inequality and range predicates represent some of the most common query predicates used in database query processing. The relevant query performance on such predicates heavily depends on access and distribution of the inspected fields' data values, as well as the type of the above-mentioned predicates used. A common bottleneck on the performance of such predicates is the physical input/output (I/O) inherent in processing them. Various index mechanisms have been specified to alleviate this problem, such as Unique Primary Index (UPI), Non-Unique Primary Index (NUPI), Unique Secondary Index (USI) and Non-Unique Secondary Index (NUSI).

### SUMMARY

Disclosed embodiments provide a system, method, and computer readable medium for allocation of a Locality-sensitive Non-Unique Secondary Index. The Locality-sensitive Non-Unique Secondary Index preserves the similarity of incorporated fields as well as improves the average secondary index sub-table look-up performance and is advantageously resilient to the type of predicates and workloads applied thereto. Rows of the secondary index having values of the columns that are hashed to determine a secondary index sub-table row location have a higher probability of being closely located within the secondary index than rows with more dissimilar column values that are hashed to determine the secondary index row location.

### BRIEF DESCRIPTION OF THE DRAWINGS

Aspects of the present disclosure are best understood from the following detailed description when read with the accompanying figures, in which:

FIG. 1 depicts a diagrammatic representation of an exemplary architecture for a large database system that is suited for implementing a locality-sensitive non-unique secondary index in accordance with disclosed embodiments;

FIG. 2 is a diagrammatic representation of a massively parallel processing system configuration suitable for implementing a locality-sensitive non-unique secondary index in accordance with disclosed embodiments;

FIG. 3 is a diagrammatic representation of a parsing engine implemented in accordance with an embodiment;

FIG. 4 is a diagrammatic representation of parser processing implemented in accordance with an embodiment;

FIG. 5A is a diagrammatic representation of a base table for which a secondary index may be generated in accordance with an embodiment;

FIG. 5B is a diagrammatic representation of a Locality-sensitive Non-Unique Secondary Index sub-table that may be generated in accordance with an embodiment; and

FIG. 6 is a flowchart of a Locality-sensitive Non-Unique Secondary Index allocation routine implemented in accordance with disclosed embodiments.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

In accordance with disclosed embodiments, a non-unique secondary index access method is provided that is referred to herein as a locality-sensitive Non-Unique Secondary Index (L-NUSI). L-NUSI preserves the similarity of incorporated fields as well as improves the average secondary index sub-table look-up performance. Further, L-NUSI is resilient to the type of predicates and workloads.

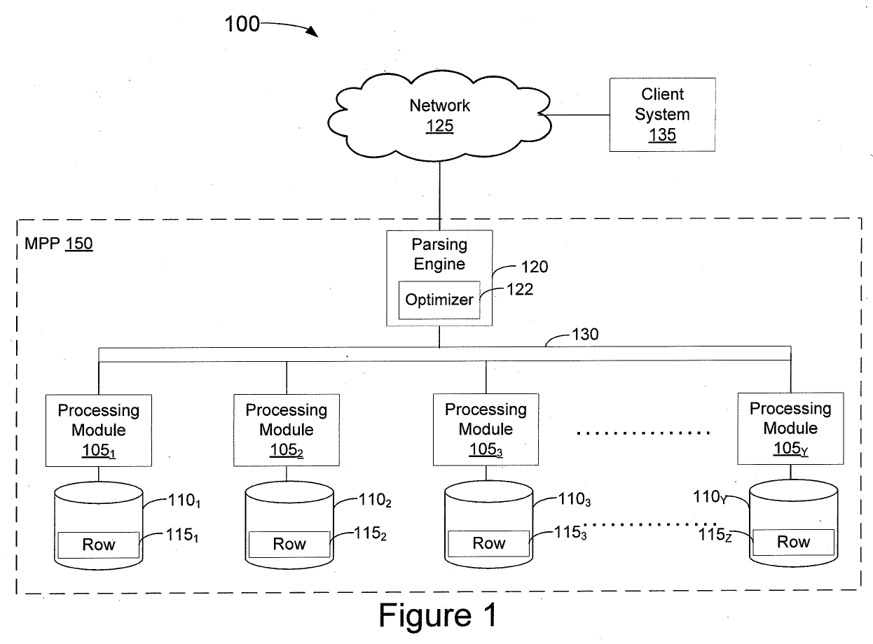

FIG. 1 depicts a diagrammatic representation of an exemplary architecture for a large database system 100, such as a Teradata Active Data Warehousing System, that is suited for implementing a locality-sensitive non-unique secondary index in accordance with disclosed embodiments. The database system 100 includes a relational database management system (RDBMS) built upon a massively parallel processing (MPP) system 150. Other types of database systems, such as object-relational database management systems (ORDBMS) or those built on symmetric multi-processing (SMP) platforms, are also suited for use. The depicted and described architecture is exemplary only and is chosen to facilitate an understanding of the disclosed embodiments.

As shown, the database system 100 includes one or more processing modules 105_{1 . . . Y} that manage the storage and retrieval of data in data-storage facilities 110_{1 . . . Y}. Each of the processing modules 105_{1 . . . Y} may be one or more physical processors or each may be a virtual processor, such as an Access Module Processor (AMP), with one or more virtual processors running on one or more physical processors. For the case in which one or more virtual processors are running on a single physical processor, the single physical processor swaps between the set of virtual processors. For the case in which N virtual processors are running on an M-processor node, the node's operating system schedules the N virtual processors to run on its set of M physical processors.

Each of the processing modules 105_{1 . . . Y} manages a portion of a database that is stored in corresponding data-storage facilities 110_{1 . . . Y}. Each of the data-storage facilities 110_{1 . . . Y} includes one or more disk drives or other storage medium.

The system stores data in one or more tables in the data-storage facilities 110_{1 . . . Y}. The rows 115_{1 . . . Z} of the tables are stored across multiple data-storage facilities 110_{1 . . . Y} to ensure that the system workload is distributed evenly across the processing modules 105_{1 . . . Y}. A parsing engine 120 organizes the storage of data and the distribution of table rows 115_{1 . . . Z} among the processing modules 105_{1 . . . Y} and accesses processing modules 105_{1 . . . Y} via an interconnect 130. The parsing engine 120 also coordinates the retrieval of data from the data-storage facilities 110_{1 . . . Y} in response to queries received from a user, such as one using a client computer system 135 connected to the database system 100 through a network connection 125. The parsing engine 120, on receiving an incoming database query, applies an optimizer component 122 to the query to assess the best plan for execution of the query. Selecting the optimal query-execution plan includes, among other things, identifying which of the processing modules 105_{1 . . . Y} are involved in executing the query and which database tables are involved in the query, as well as choosing which data-manipulation techniques will serve best in satisfying the conditions of the query. Database statistics are used in making these assessments during construction of the query-execution plan. For example, database statistics may be used by the optimizer to determine data demographics, such as attribute minimum and maximum values and data ranges of the database. The database system typically receives queries in a standard format, such as the Structured Query Language (SQL) put forth by the American National Standards Institute (ANSI).

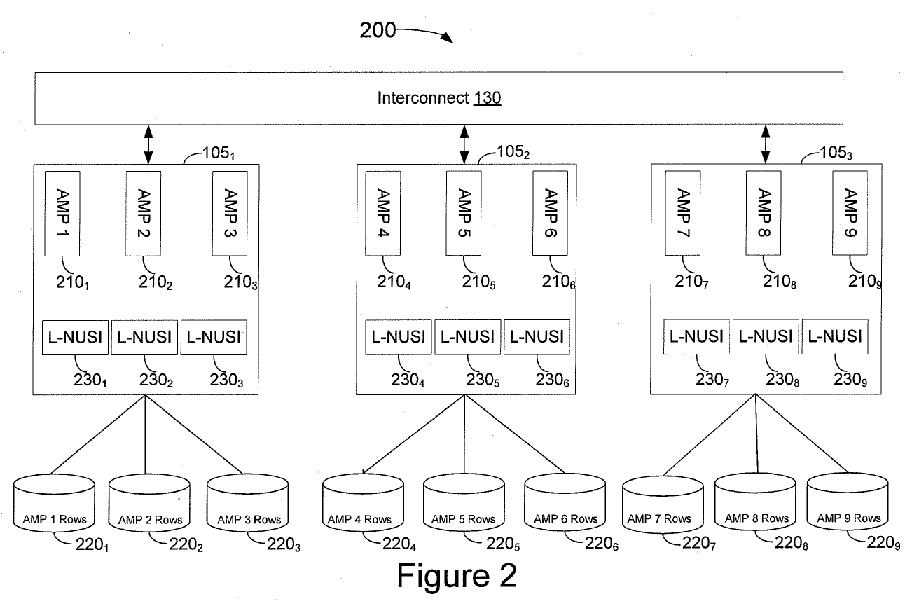

FIG. 2 is a diagrammatic representation of an MPP configuration 200 suitable for implementing a locality-sensitive non-unique secondary index in accordance with disclosed embodiments. In the illustrative example, each of the processing modules 105₁-105₃ are each configured with three respective AMPs 210₁-210₉. The rows 115_{1 . . . Z} of a table have been distributed across the nine AMPs 210₁-210₉ hosted by processing modules 105₁-105₃ such that each of the AMPs is allocated rows 220₁-220₉. In accordance with an embodiment, AMPs 210₁-210₉ may have a respective Locality-sensitive Non-Unique Secondary Index (L-NUSI) 230₁-230₉ allocated thereto and implemented in accordance with disclosed embodiments as described more fully hereinbelow.

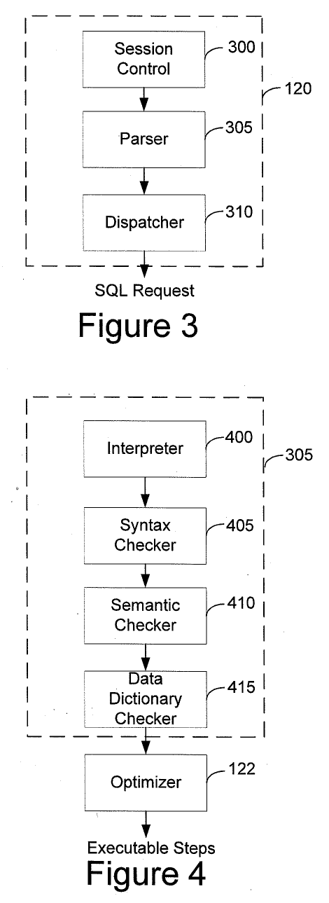

In one example system, the parsing engine 120 is made up of three components: a session control 300, a parser 305, and a dispatcher 310, as shown in FIG. 3. The session control 300 provides the logon and logoff function. It accepts a request for authorization to access the database, verifies it, and then either allows or disallows the access. Once the session control 300 allows a session to begin, a user may submit a SQL request that is routed to the parser 305. As illustrated in FIG. 4, the parser 305 interprets the SQL request (block 400), checks the request for correct SQL syntax (block 405), evaluates the request semantically (block 410), and consults a data dictionary to ensure that all of the objects specified in the SQL request exist and that the user has the authority to perform the request (block 415). Finally, the parser 305 runs the optimizer 122 that selects the least expensive plan to perform the request.

An important element of the Teradata Active Data Warehousing System available is the “primary index” column that the database system's user assigns for each table. The database system hashes the rows of each table, using the primary index column as the basis for the hash, and distributes the rows among the data storage facilities 110_{1 . . . Y} based on the hash results. If the primary index column is properly selected, the distribution technique evenly distributes the rows of each table across all of the data storage facilities 110_{1 . . . Y} in the system. This is true if the chosen primary index column has unique values, producing a unique primary index (UPI), but is not always true if the chosen primary index column has non-unique values, producing a non-unique primary index (NUPI). The same hashing technique is used to retrieve rows of data from a table, as the primary index provides a path to the rows of a table.

The Teradata Active Data Warehousing System also provides a secondary index capability, which provides an alternative path to the rows of a table. A table can have more than one secondary index. Unlike a primary index, a secondary index does not affect the distribution of table rows among data storage facilities 110_{1 . . . Y}. In particular, secondary indexes including NUSI (Non-Unique Secondary Index) are introduced for faster set selection and implemented on an AMP-local basis. Each AMP 210₁-210₉ manages the NUSI sub-table rows that correspond to base table rows located on that AMP only. The distribution of a NUSI sub-table row is based on the Primary Index of its base row so that the system can access the NUSI row and the corresponding base row on the same AMP. However, in some cases, it is more beneficial to sort the NUSI sub-table rows by data values rather than by hash code, so called “Value-ordered NUSI”. This is accomplished through a user-specified syntax option in the CREATE INDEX command syntax. In general, with each NUSI sub-table, the index rows may be ordered based on their a) NUSI hash code, or b) the NUSI data value itself.

Value-ordered NUSI (VO-NUSI) is efficient for processing the following types of queries:
1. Range predicates, which returns values in between the upper and lower limit values of the predicate
2. Inequality predicates defined on the secondary index columns

For instance, the following example query returns information from an EMPLOYEE table regarding employees who were hired in January of 2006:
SELECT *
FROM employee
WHERE hire_date BETWEEN 060101 AND 060131;

In contrast, the typical use of Hash-ordered NUSI (HO-NUSI) is with cases where:
1. Equality predicates are defined on the secondary index column(s)
2. The NUSI will participate in a nested-join, where join conditions involve only one ordering column

In such uses, the NUSI sub-table rows are stored in row hash order instead, for instance for a query such as the following:
SELECT*
FROM employee
WHERE hire_date=060131;

The advantage of using VO-NUSIs for range and secondary index (SI) inequality conditions is that although HO-NUSIs can be selected by the Query Optimizer to access rows based on range conditions, a far more common response is to perform a full sub-table scan of the NUSI sub-table to find the matching SI values. For instance, when accessing data with two NUSI equality conditions joined by an OR operator, the database system may perform a full sub-table scan.

Contemporary HO-NUSI mechanisms are not very efficient data access method for large-scale sub-tables in conjunction with range/inequality predicates. VO-NUSI sorts the rows based on their data value and reduces the sub-table search space to only a portion of the index sub-table for a given range of key values. A column defined as a VO-NUSI must be a single column. If the user does not specify ORDER BY VALUES upon the NUSI creation, the database system may sort the NUSIs in hash order by default. User workloads may impose combination of Range, Inequality and Equality and predicates on a particular NUSI.

In accordance with embodiments, a HO-NUSI framework is provided that stores, orders and retrieves sub-table entries using a hash function that preserves the value-order of its underlying data values.

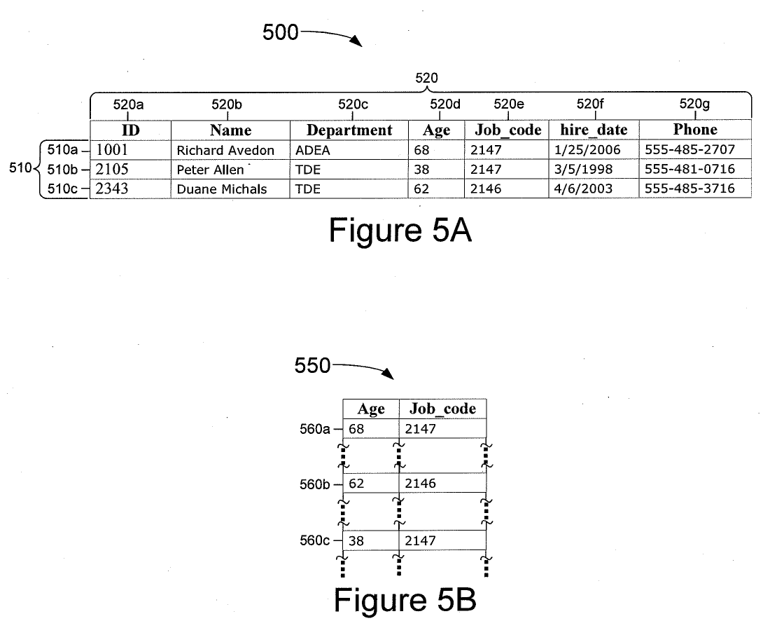

Assume p and q are two rows on a set of d comparable field (e.g., INTEGER, DATE, DECIMAL, etc.) columns R^{d}. In other words, p and q may be visualized as points in a multi-dimensional space. For instance, consider the diagrammatic representation of an employee table 500, or a portion thereof, as depicted in FIG. 5A. Table 500 comprises a plurality of records 510a-510c (collectively referred to as records 510) and fields 520a-520g (collectively referred to as fields 520). Each record 510 comprises data elements in respective fields 520.

In the present example, table 500 includes fields 520 having respective labels of “ID”, “Name”, “Department”, “Age”, “Job_code”, “hire date”, and “Phone.” Data elements of a particular field typically share a common data type, e.g., string, integer, float, etc.

An example of p and q (defined on age and job_code columns) may be p=(68, 2147) and q=(38,2147). The distance between p and q may be defined, in one definition, as d(p,q)=(|68−38|,|2147−2147|)=30+0=30. That is, the distance may be defined as the sum of the numeric distance, or difference, between respective column values for columns 520d and 520e of respective rows 510a and 510b.

A hash function h: R^{d}→U is referred to herein as a Locality-Sensitive Hash function (LSH) if the function hashes rows to a common hash bucket with higher probability in the event the hash columns are more locally proximate than if the hash columns are more relatively distant. Some portion, possibly the entirety, of the hash value is designated a “hash bucket”. The hash buckets are assigned to a particular secondary index location, e.g., memory address, and define to where a row of the secondary index is to be allocated in the secondary index based on the hash value by way of a hash bucket map. The locality or distance of the hash columns may be defined, in one embodiment, as the difference in the hash column values, or the sum of the distance of the hash column values. For example,
If ∥p−q∥<r, then Pr[h(p)=h(q)]>P1
If ∥p−q∥>cr, then Pr[h(p)=h(q)]<P2
   for, P1, P2, r, c (constant), and a distant function d(p,q)=∥p−q∥. P1 and P2 are properties of the hash function, and P1 may comprise a larger value than P2. The larger the P1 value and the lower the P2 value, the more effective the hash function. In other words, h hashes the rows p and q to the same buckets with a high probability if they are close to each other, and maps the dissimilar rows p and q to the same bucket with a low probability if they are not close to each other. The properties of P1 and P2 depend on the choice of the hash function. Advantageously, rows of the secondary index have a higher probability of being located close to one another in the secondary index if the columns on which the hash values are calculated have values that are numerically close to one another than if the values are more numerically distant from one another. In this manner, the secondary index preserves the similarity of incorporated fields as well as improves the average secondary index sub-table look-up performance. Further, the L-NUSI is resilient to the type of predicates and workloads applied thereto.

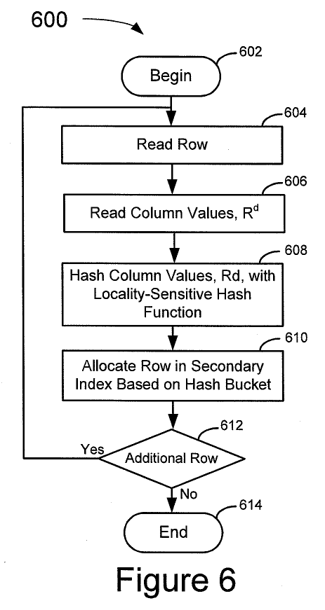

FIG. 6 is a flowchart 600 of a L-NUSI allocation routine implemented in accordance with disclosed embodiments. The processing steps of FIG. 6 may be implemented as computer-executable instructions tangibly embodied on a computer-readable medium executable by a processing system, such as one or more of the AMPs 210₁-210₉ depicted in FIG. 2.

The L-NUSI allocation routine is invoked (step 602), and a row for which a corresponding secondary index row is to be allocated is read from the base table (step 604). The column values, R^{d}, on which the locality-sensitive hash is to be calculated are then read from the row (step 606). The column values, R^{d}, are then hashed with a locality-sensitive hash function (step 608). A secondary index row is then allocated based on the hash bucket resulting from the hash of the column values R^{d} (step 610). That is, the position of the secondary index row is based on the hash value of the column values R^{d}. An evaluation may then be made to determine if another base table row remains for allocation of a corresponding secondary index row (step 612). If another row remains, the L-NUSI allocation routine may then return to read the row from the base table according to step 604. When no additional rows remain, the L-NUSI allocation routine cycle may then end (step 614).

Accordingly, rows of the secondary index having values of the hashed columns have a higher probability of being closely located within the secondary index than rows with dissimilar column values that are hashed. For instance, the rows 560a and 560b of the secondary index sub-table 550 depicted in FIG. 5B that correspond to rows 510a and 510c of the base table 500 are more likely to be relatively proximate to one another than, for example, the rows 560a and 560c of the secondary index that correspond to the base table rows 510a and 510b due to the more numerical closeness of the column values R^{d} on which the hash value is generated and on which the locations of the secondary index rows are based.

As described, a method, computer-readable medium, and system that facilitate allocation of a Locality-sensitive Non-Unique Secondary Index are provided. The L-NUSI preserves the similarity of incorporated fields as well as improves the average secondary index sub-table look-up performance and is advantageously resilient to the type of predicates and workloads applied thereto. Rows of the secondary index having values of the columns that are hashed to determine a secondary index sub-table row location have a higher probability of being closely located within the secondary index than rows with more dissimilar column values that are hashed to determine the secondary index row location.

The flowchart of FIG. 6 depicts process serialization to facilitate an understanding of disclosed embodiments and is not necessarily indicative of the serialization of the operations being performed. In various embodiments, the processing steps described in FIG. 6 may be performed in varying order, and one or more depicted steps may be performed in parallel with other steps. Additionally, execution of some processing steps of FIG. 6 may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer. The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information. Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

What is claimed is:

1. A method of generating a secondary index sub-table in a database system, comprising:
reading a column value of a row of a base table;
hashing the column value with a locality-sensitive hash function thereby producing a hash value; and
allocating a secondary index row corresponding to the base table row, wherein a position of the secondary index row is based on the hash value.

2. The method of claim 1, wherein reading a column value comprises reading a plurality of column values of the base table row, and wherein hashing the column value comprises hashing the plurality of column values.

3. The method of claim 1, further comprising obtaining a hash bucket from the hash value.

4. The method of claim 3, wherein allocating a secondary index row comprises determining the location of the secondary index row based on the hash bucket.

5. The method of claim 1, wherein reading a column value of a row comprises reading a respective column value of a plurality of rows of the base table, hashing the column value comprises hashing each respective column value of the plurality of rows, and allocating a secondary index row comprises allocating a respective secondary index row for each of the plurality of rows.

6. The method of claim 1, wherein a first row and a second row of the plurality of rows have respective column values more numerically proximate than the first row and a third row of the plurality of rows.

7. The method of claim 6, wherein the probability that secondary index rows corresponding to the first row and the second row are located more proximate to one another is greater than the probability that the secondary index rows corresponding to the first row and the third row are located more proximate to one another.

8. A computer-readable medium having computer-executable instructions for execution by a processing system, the computer-executable instructions for generating a secondary index sub-table in a database system, the computer-executable instructions, when executed, cause the processing system to:
read a column value of a row of a base table;
hash the column value with a locality-sensitive hash function thereby producing a hash value; and
allocate a secondary index row corresponding to the base table row, wherein a position of the secondary index row within the secondary index is based on the hash value.

9. The computer-readable medium of claim 8, wherein the instructions that read a column value comprise instructions that, when executed, cause the processing system to read a plurality of column values of the base table row, and wherein the instructions that hash the column value comprise instructions that, when executed, cause the processing system to hash the plurality of column values.

10. The computer-readable medium of claim 8, further comprising instructions that, when executed, cause the processing system to obtain a hash bucket from the hash value.

11. The computer-readable medium of claim 10, wherein the instructions that allocate a secondary index row comprise instructions that, when executed, cause the processing system to determine the location of the secondary index row based on the hash bucket.

12. The computer-readable medium of claim 8, wherein the instructions that read a column value of a row comprise instructions that, when executed, cause the processing system to read a respective column value of a plurality of rows of the base table, the instructions that hash the column value comprise instructions that, when executed, cause the processing system to hash each respective column value of the plurality of rows, and the instructions that allocate a secondary index row comprise instructions that, when executed, cause the processing system to allocate a respective secondary index row for each of the plurality of rows.

13. The computer-readable medium of claim 8, wherein a first row and a second row of the plurality of rows have respective column values more numerically proximate than the first row and a third row of the plurality of rows.

14. The computer-readable medium of claim 13, wherein the probability that secondary index rows corresponding to the first row and the second row are located more proximate to one another is greater than the probability that the secondary index rows corresponding to the first row and the third row are located more proximate to one another.

15. A database system, comprising:
a processing module; and
a storage device communicatively coupled with the processing module and allocated thereto that stores a base table allocated to the processing module, wherein the processing module reads a column value of a row of the base table, hashes the column value with a locality-sensitive hash function thereby producing a hash value, and allocates a secondary index row corresponding to the base table row, wherein a position of the secondary index row within the secondary index is based on the hash value.

16. The system of claim 15, wherein the processing module reads a plurality of column values of the base table row and hashes the plurality of column values.

17. The system of claim 15, wherein the processing module obtains a hash bucket from the hash value.

18. The system of claim 17, wherein the processing module determines the location of the secondary index row based on the hash bucket.

19. The system of claim 15, wherein the processing module reads a respective column value of a plurality of rows of the base table, hashes each respective column value of the plurality of rows, and allocates a respective secondary index row for each of the plurality of rows.

20. The system of claim 15, wherein a first row and a second row of the plurality of rows have respective column values more numerically proximate than the first row and a third row of the plurality of rows, and wherein the probability that secondary index rows corresponding to the first row and the second row are located more proximate to one another is greater than the probability that the secondary index rows corresponding to the first row and the third row are located more proximate to one another.
